(19) United States
(12) Patent Application Publication
(10) Pub. No.: US 2026/0275103 A1
(43) Pub. Date: Sep. 17, 2026

(54) MOLDED BODY, DOWNHOLE TOOL MEMBER, AND DOWNHOLE TOOL

(71) Applicant: Kureha Corporation, Tokyo (JP)

(72) Inventors: Motoharu SHODA, Tokyo (JP); Takuma KOBAYASHI, Tokyo (JP); Fuminori KOBAYASHI, Tokyo (JP); Natsumi SATO, Tokyo (JP)

(73) Assignee: Kureha Corporation, Tokyo (JP)

(21) Appl. No.: 19/168,172

(22) PCT Filed: Mar. 22, 2024
(86) PCT No.: PCT/JP2024/011213

§ 371 Date: Sep. 23, 2025

(30) Foreign Application Priority Data
Mar. 28, 2023 (JP) 2023-051976

(51) Int. Cl. C08L 67/04; C08K 3/22; C08K 5/1539

(52) U.S. Cl. CPC C08L 67/04; C08K 3/22; C08K 5/1539; C08K 2003/222

(57) ABSTRACT

Provided is a molded body that has an improved thickness reduction rate after a thickness reduction of 5 mm or greater from its initial thickness, while maintaining tensile strength. The molded body of the present invention includes a glycolic acid polymer, a cyclic ester, a basic metal oxide and a carboxylic anhydride. A content of the cyclic ester is 21 parts by mass or less when a total mass of the glycolic acid polymer, the cyclic ester, the basic metal oxide, and the carboxylic anhydride is 100 parts by mass. The shortest interparticle distance of the basic metal oxide is 9.1 μm or less.

### TECHNICAL FIELD

The present invention relates to: a molded body including a composition containing a glycolic acid polymer; a downhole tool member including the molded body; and a downhole tool containing the downhole tool member.

### BACKGROUND ART

A glycolic acid polymer has high strength and is a degradable resin material having hydrolyzability and degradability. Because of such characteristics, glycolic acid polymers are used as medical materials such as bone fixation materials and sutures. Also, in recent years, their applications as a member of a downhole tool used for recovery of hydrocarbon resources is expanding. Depending on the applications, higher degradation rates are demanded, and various research and development have been conducted to improve the degradation rates of glycolic acid polymers.

For example, Patent Document 1 discloses that a molded body including a composition containing a glycolic acid polymer, a plasticizer, and a degradation accelerator can have an improved degradation rate.

### CITATION LIST

### Patent Document

Patent Document 1: WO 2022/209885

### SUMMARY OF INVENTION

### Technical Problem

A molded body including a resin composition containing a glycolic acid polymer is useful as a material for a downhole tool or a member thereof from the perspective of degradability and strength of the molded body. Further improvement in degradation rate of a molded body is demanded in use of a molded body containing a glycolic acid polymer in a downhole tool or a member thereof. In particular, it is required that a molded body having a thickness greater than 5 mm has an improved thickness reduction rate after a thickness reduction of 5 mm or greater from its initial thickness while maintaining the tensile strength.

However, according to the study of the present inventors, it has been found that the molded body including the resin composition disclosed in Patent Document 1 has a decreased thickness reduction rate after a thickness reduction of 5 mm or greater from its initial thickness. In addition, from the perspective of strength, it has been found that the tensile strength tends to decrease as the thickness reduction rate is improved.

An object of an aspect of the present invention is to provide a molded body having an improved thickness reduction rate after a thickness reduction of 5 mm or greater from its initial thickness while maintaining the tensile strength.

### Solution to Problem

As a result of intensive studies, the present inventors have found that a cyclic ester, a basic metal oxide, and a carboxylic anhydride are contained in a composition, in addition to a glycolic acid polymer, thereby improving the thickness reduction rate of a molded body after a thickness reduction of 5 mm or greater from its initial thickness. Moreover, the present inventors have also found that the reduction in tensile strength of the molded body at 49° C. is suppressed, and thus the present invention has been completed.

A molded body according to an aspect of the present invention is a molded body including a glycolic acid polymer, a cyclic ester, a basic metal oxide and a carboxylic anhydride, in which a content of the cyclic ester is 21 parts by mass or less when a total mass of the glycolic acid polymer, the cyclic ester, the basic metal oxide, and the carboxylic anhydride is 100 parts by mass, the shortest interparticle distance of the basic metal oxide is 9.1 μm or less, and the molded body has a thickness or a diameter greater than 5 mm.

A molded body according to another aspect of the present invention is a molded body including a glycolic acid polymer, a cyclic ester, a basic metal oxide and a carboxylic anhydride, in which, when held in water at 49° C., the molded body has a thickness reduction rate of 0.080 mm/h or greater after a thickness reduction of 5 mm or greater from its initial thickness.

### Advantageous Effects of Invention

According to an aspect of the present invention, it is possible to provide a molded body having an improved thickness reduction rate after a thickness reduction of 5 mm or greater from its initial thickness while maintaining the tensile strength.

### BRIEF DESCRIPTION OF THE DRAWINGS

FIG. 1 is a graph showing correlation between the shortest interparticle distance of a basic metal oxide and a thickness reduction rate of a molded body in a late stage of degradation, according to Examples 15 to 18 and Comparative Example 15 of the present invention.

### DESCRIPTION OF EMBODIMENTS

### Molded Body

A molded body according to the present embodiment includes a composition containing a glycolic acid polymer, a cyclic ester, a basic metal oxide, and a carboxylic anhydride. In other words, the molded body according to the present embodiment is a molded body including a glycolic acid polymer, a cyclic ester, a basic metal oxide, and a carboxylic anhydride.

### Glycolic Acid Polymer

In the present specification, the glycolic acid polymer is a polymer containing a repeating unit (-(—O—CH₂—CO—)-) derived from glycolic acid. The glycolic acid polymer may be a homopolymer of glycolic acid (polyglycolic acid (PGA)). Furthermore, the glycolic acid polymer may be a copolymer containing a repeating unit derived from glycolic acid and a repeating unit derived from another monomer.

When the glycolic acid polymer is a homopolymer of glycolic acid, a weight average molecular weight (Mw) of the glycolic acid polymer is preferably 150000 or greater, more preferably 160000 or greater, and even more preferably 170000 or greater, from the perspectives of maintaining of the strength of the molded body and extrusion molding. Furthermore, from the perspective of facilitating molding at the time of extrusion molding or injection molding, the Mw of the glycolic acid polymer is preferably 500000 or less, more preferably 450000 or less, and even more preferably 400000 or less.

The copolymer containing a repeating unit derived from glycolic acid and a repeating unit containing another monomer (hereinafter, referred to as “glycolic acid copolymer”) will be described below.

### Glycolic Acid Copolymer

From the perspective of improvement in degradation rate, the glycolic acid copolymer may be a copolymer including two or more linear polymer chains A, each containing a repeating unit derived from glycolic acid, chemically bonded to a polymer chain B that is different from the polymer chain A. The polymer chain A and the polymer chain B will be described below.

In the glycolic acid copolymer, two or more polymer chains A are only required to be chemically bonded to a polymer chain B, and bonding positions of the polymer chains A in the polymer chain B are not particularly limited. For example, the copolymer may be a triblock copolymer, in which a polymer chain A is chemically bonded to both terminals of the main chain of a polymer chain B (“ABA-type block copolymer”, where A is the polymer chain A, and B is the polymer chain B), or may be a graft copolymer, in which two or more polymer chains A are graft-bonded to a polymer chain B.

From the perspective of more excellent improvement effect in the thickness reduction rate during degradation in the production of a molded body using the glycolic acid copolymer, the copolymer is preferably an ABA-type block copolymer (where A is the polymer chain A, and B is the polymer chain B).

Furthermore, in the glycolic acid copolymer, the polymer chain A and the polymer chain B are preferably bonded by an ester bond. Consequently, an improvement effect in the thickness reduction rate during degradation in the production of a molded body using the glycolic acid copolymer composition is readily achieved.

In particular, in a case where the polymer chain B is a unit having a higher hydrophilicity or flexibility than that of the polymer chain A, the polymer chain A and the polymer chain B are particularly preferably bonded via an ester bond. Specifically, in a case where the polymer chain B is a unit having a higher hydrophilicity or flexibility than that of the polymer chain A, water tends to permeate around the polymer chain B rather than around the polymer chain A, and the ester bond between the polymer chain A and the polymer chain B readily hydrolyzes compared to the ester bond in the polymer chain A. Namely, the glycolic acid copolymer is easily ruptured between the polymer chain A and the polymer chain B upon hydrolysis of the ester bond between the polymer chain A and the polymer chain B. This greatly reduces the molecular weight of the polymer, and thus the thickness reduction rate tends to be improved.

The polymer chain A and the polymer chain B constituting the glycolic acid copolymer will be described below.

### Polymer Chain A

Examples of the polymer chain A include a linear polymer chain containing a glycolic acid unit. The number of glycolic acid units constituting one block of the polymer chain A in the glycolic acid copolymer are not particularly limited, and can be appropriately determined in such a range that the glycolic acid copolymer can exhibit degradability originating from the polymer chain A.

### Polymer Chain B

The polymer chain B is a polymer chain different from the polymer chain A. For example, the polymer chain B may be a polymer chain derived from a polymer compound having a glass transition temperature (Tg) lower than 45° C. Furthermore, the polymer chain B may be a polymer chain derived from a polymer compound having a weight average molecular weight of 1500 or greater and 250000 or less.

The glass transition temperature of the polymer compound as the source of the polymer chain B (hereinafter, “polymer compound B”) is preferably 45° C. or lower, and more preferably 0° C. or lower, from the perspective of making the glass transition temperature of the glycolic acid copolymer lower than that of a polymer consisting of the polymer chain A only. The glass transition temperature of the polymer compound as the source of the polymer chain B can be measured by differential scanning calorimetry (DSC).

The weight average molecular weight of the polymer compound B is preferably 2500 or greater, more preferably 3000 or greater, and even more preferably 7500 or greater, from the perspective of further improving the thickness reduction rate of the molded body during degradation. From the perspective of further improving the strength of the molded body, the weight average molecular weight of the polymer compound B is preferably 50000 or less, and more preferably 20000 or less. The polymer compound B having an weight average molecular weight of 50000 or less is advantageous from the perspectives of solubility in glycolide during polymerization of the glycolic acid copolymer and control of copolymerizability. The weight average molecular weight of the polymer compound B can be measured by a gel permeation chromatography (GPC) instrument.

The polymer compound B is not particularly limited as long as the polymer compound B is a polymer compound that is not polyglycolic acid and that has, at two or more terminals, functional groups capable of chemically bonding with glycolic acid units constituting the polymer chain A to function as a polymerization initiator and has a weight average molecular weight and/or a glass transition temperature in the specific ranges.

Examples of the polymer compound B described above include a polyol having the specific weight average molecular weight and glass transition temperature. Examples of the polyol include polyethylene glycol, polypropylene glycol, polytetramethylene ether glycol, polycaprolactone, polydioxanone, polydimethylsiloxane, and polyethylene oxalate. “Polyol” may be a homopolymer containing only one type of repeating unit, or may be a copolymer further containing a repeating unit derived from another monomer.

From the perspective of imparting hydrophilicity to the glycolic acid copolymer, the polymer compound B is preferably a hydrophilic polyhydric alcohol-based polymer having a terminal hydroxy group. Examples of the hydrophilic polyhydric alcohol-based polymer having a terminal hydroxy group include polyethylene glycol, polypropylene glycol, polyglycerin, and polyvinyl alcohol.

In an aspect of the present invention, the polymer compound B may be a hydrophilic polyhydric alcohol having a terminal hydroxy group and having a weight average molecular weight of 3000 or greater and 50000 or less. When the polymer compound B is a hydrophilic polyhydric alcohol having a terminal hydroxy group and having a weight average molecular weight of 3000 or greater and 50000 or less, the hydrophilicity of the polymer chain B is exhibited in the glycolic acid copolymer, and thus affinity for water during degradation improves. As a result, an effect of further improving the thickness reduction rate of the molded body during degradation is achieved.

In another aspect of the present invention, the polymer compound B may be polyethylene glycol or polypropylene glycol having a weight average molecular weight of 3000 or greater and 50000 or less. The polyethylene glycol and polypropylene glycol has a particularly low glass transition temperature and particularly high hydrophilicity. Thus, when the hydrophilic polyhydric alcohol having a terminal hydroxy group is polyethylene glycol or polypropylene glycol, an effect of imparting flexibility and hydrophilicity to the glycolic acid copolymer is achieved.

In another aspect of the present invention, the polymer compound B may be polyethylene glycol having a weight average molecular weight of 7500 or greater and 50000 or less. When the polymer compound B is polyethylene glycol having a weight average molecular weight of 7500 or greater and 50000 or less, an effect of further improving the thickness reduction rate of the molded body during degradation is achieved.

The polymer compound B may be a homopolymer containing a repeating unit derived from one monomer, or may be a copolymer further containing a repeating unit derived from another monomer.

Examples of such other monomers include cyclic monomers such as ethylene oxalate (1,4-dioxane-2,3-dione), lactides, lactones (e.g., β-propiolactone, β-butyrolactone, β-pivalolactone, γ-butyrolactone, δ-valerolactone, β-methyl-δ-valerolactone, and ε-caprolactone), carbonates (e.g., trimethylene carbonate), ethers (e.g., 1,3-dioxane), ether esters (e.g., dioxanone), and amides (e.g., ε-caprolactam); hydroxycarboxylic acids and alkylesters thereof, such as lactic acid, 3-hydroxypropanoic acid, 3-hydroxybutanoic acid, 4-hydroxybutanoic acid, and 6-hydroxycaproic acid; mixtures containing substantially equimolar amounts of an aliphatic diol, such as ethylene glycol, propylene glycol, tetramethylene ether glycol, or 1,4-butanediol, and an aliphatic dicarboxylic acid, such as succinic acid or adipic acid, or an alkylester thereof; and two or more types of these.

The repeating unit derived from another monomer can be used from the perspective of adjusting physical properties of the polymer compound B. For example, use of the other repeating unit allows adjustment of the affinity of the polymer compound B for water. The content of another repeating unit in the polymer compound B can be appropriately determined in such a range that the desired effect of the polymer chain B is adequately achieved. The content of a repeating unit derived from another monomer in the polymer compound B may be 50 mass % or less, and is preferably 30 mass % or less, and even more preferably 10 mass % or less. The polymer compound B may be linear, or may be a graft copolymer to which another polymer compound is graft-bonded.

The polymer chain B may have an ester bond in the molecule. When the polymer chain B has an ester bond in the molecule, rupture resulting from hydrolysis of an ester bond also occurs in the polymer chain B, the thickness reduction rate tends to be further improved.

From the perspectives of allowing the hydrophilicity of the polymer chain B to be adequately exhibited in the glycolic acid copolymer and improving the thickness reduction rate of the molded body during degradation, the amount of the polymer chain B in the glycolic acid copolymer is, in mass ratio, preferably 0.5 or greater, and more preferably 1.5 or greater, relative to a total amount of the polymer chain A of 100. Furthermore, from the perspective of maintaining the strength of the glycolic acid copolymer, the amount of the polymer chain B in the glycolic acid copolymer is, in mass ratio, preferably 30 or less, and more preferably 20 or less, relative to the total amount of the polymer chain A of 100.

The glycolic acid polymer can be produced by a known method. For example, the glycolic acid copolymer can be suitably produced by ring-opening polymerization of glycolide, which is a glycolic acid dimer, in the presence of a small amount of a catalyst and in the substantial absence of a solvent (i.e., under bulk polymerization conditions) using the polymer compound B, which is the source of the polymer chain B, as a polymerization initiator. The reaction temperature in the ring-opening polymerization can be appropriately determined in such a range that the ring-opening polymerization of glycolide can appropriately proceed, and is, for example, 140° C. Examples of the catalyst include a cationic catalyst such as an organotin carboxylate, a tin halide, and an antimony halide. Commercially available products of the glycolic acid polymer may also be used.

### Content of Glycolic Acid Polymer

A content of the glycolic acid polymer in the composition of the present embodiment, that is, a content of the glycolic acid polymer is preferably 50 parts by mass or greater and 97 parts by mass or less, when a total of the glycolic acid polymer, the cyclic ester, the basic metal oxide, and the carboxylic anhydride in the molded body of the present embodiment is 100 parts by mass. The content of the glycolic acid polymer is preferably 50 parts by mass or greater from the perspective of sufficiently securing the tensile strength of the composition. From the perspective of improving the tensile strength, the content of the glycolic acid polymer is more preferably 55 parts by mass or greater, and even more preferably 60 parts by mass or greater. As described later, the cyclic ester, the basic metal oxide, and the carboxylic anhydride have a degradation accelerating effect on the glycolic acid polymer. Therefore, the content of the glycolic acid polymer of 97 parts by mass or less is preferable from the perspective of increasing the thickness reduction rate because a content of the compound having a degradation accelerating effect is relatively increased. From the perspective of increasing the thickness reduction rate, the content is more preferably 90 parts by mass or less, and even more preferably 80 parts by mass or less.

### Cyclic Ester

Examples of the cyclic ester contained in the composition according to the present embodiment include glycolide, lactide, ¿-caprolactone, γ-valerolactone, δ-valerolactone, diglycolic anhydride, and glutaric anhydride. Among them, glycolide or ε-caprolactone is particularly preferable because of its high plasticizing effect. One type of cyclic ester may be used alone, or two or more types thereof may be used in combination.

In the composition according to the present embodiment, the absolute value of the difference between the Fedors solubility parameter of the cyclic ester and the Fedors solubility parameter of the glycolic acid polymer is preferably 6.0 (J/cm³)^{1/2} or less, more preferably 5.5 (J/cm³)^{1/2} or less, and even more preferably 5.0 (J/cm³)^{1/2} or less. Hereinafter, “Fedors solubility parameter” may be abbreviated as “SP value”. When the absolute value of the difference between the SP value of the cyclic ester and the SP value of the glycolic acid polymer is within the range described above, the composition has sufficient plasticity.

The SP value can be calculated, for example, according to “SP value: Foundation/Application and Calculation Method” (published by Johokiko Co., Ltd. (2005) pp. 66-67) by Hideki Yamamoto. More specifically, the SP value δ ((cal/cm³)^{1/2}) of a target compound (glycolic acid polymer or cyclic ester) is calculated according to the following equation (1).

$$δ = {( \sum Ecoh / \sum V )}^{1 / 2} \qquad ( 1 )$$

In Equation (1), ΣEcoh represents the sum total of Ecoh (cohesive energy density of a structural unit of a target compound (cal/cm³)), and ΣV represents V (molar volume of a structural unit of a target compound (cm³)).

When two or more types of cyclic esters are contained in the composition described above, the absolute value of the difference between the SP value of at least one type of cyclic ester and the SP value of glycolic acid polymer is preferably 6.0 (J/cm³)^{1/2} or less.

The structure of the cyclic ester contained in the composition can be identified by, for example, performing gas chromatography-mass spectrometry (GCMS analysis) and comparing the analysis results with known compounds as standard materials. In addition, the structure of the cyclic ester can be identified by using other analysis methods such as NMR measurement and FT-IR in combination as necessary.

A content of the cyclic ester in the composition is preferably 3 parts by mass or greater, more preferably 5 parts by mass or greater, and even more preferably 7 parts by mass or greater, when the total of the glycolic acid polymer, the cyclic ester, the basic metal oxide, and the carboxylic anhydride is 100 parts by mass. In addition, the content is 21 parts by mass or less, preferably 20 parts by mass or less, more preferably 18 parts by mass or less, and even more preferably 17 parts by mass or less. When the content of the cyclic ester is within the range described above, the glass transition temperature (Tg) of the composition can be sufficiently lowered, sufficient plasticity can be imparted to the composition, and the tensile strength of the composition can be sufficiently secured. In an aspect of an embodiment of the present invention, the content of the cyclic ester in the composition is preferably 3 mass % or greater, more preferably 5 mass % or greater, and even more preferably 7 mass % or greater relative to 100 mass % of the composition. In addition, the content is 21 mass % or less, preferably 20 mass % or less, more preferably 18 mass % or less, and even more preferably 17 mass % or less.

The content of the cyclic ester in the composition can be calculated from a ratio of materials to be charged. Alternatively, for example, it can also be measured by GCMS analysis. An example of gas chromatography (GC) measurement is indicated below.

### Method for Preparing Sample:

To about 100 mg of a composition, p-chlorobenzophenone-containing dehydrated DMSO (0.4 mg/2 ml) is added and heated and dissolved at 160° C. for about 10 minutes. After the solution is cooled to room temperature, the solution is filtered. Gas chromatography (GC) measurement is performed for the obtained filtrate.

### Measurement Conditions:

Instrument: GC-2010, available from the Shimadzu Corporation
Column: RESTEK Rxi-5 ms
Column temperature: Retention at 150° C. for 5 minutes, then temperature
increase at 20° C./min, and then retention at 270° C. for 3 minutes
Injection temperature: 180° C.

### Basic Metal Oxide

Examples of the basic metal oxide contained in the composition according to the present embodiment include magnesium oxide, zinc oxide, calcium oxide, sodium oxide, and copper oxide. Among them, the strong base metal oxide degrades the polymer itself of the base material, and therefore, magnesium oxide or zinc oxide, which is a weak base metal oxide or an amphoteric metal oxide, is preferable. In addition, since the basic metal oxides are characterized in that they remain in the molded body and are less likely to be eluted as compared with cyclic esters and carboxylic anhydrides, the thickness reduction rate can be kept high even in a long period of time in which the thickness is reduced by 5 mm or greater.

The shortest interparticle distance of the basic metal oxide in the molded body according to the present embodiment is preferably 0.35 μm or greater, and more preferably 0.50 μm or greater. The shortest interparticle distance is 9.1 μm or less, preferably 4.0 μm or less, and more preferably 1.0 μm or less. In the present specification, the “shortest interparticle distance” is defined as an average value of distances between the center of gravity of an arbitrary metal oxide particle and the center of gravity of another metal oxide particle nearest the center of gravity in an arbitrary cross section of the molded body. Specifically, the distance is obtained by measuring distances between particles detected in an electron microscope image at a magnification of 3000 times using, for example, a scanning electron microscope, the entire edges of the particles being included in the image, and calculating an average value thereof. For example, a molded body having a cubic shape with a side length of 5 mm is cut out into a rectangular parallelepiped shape of 2 mm×2 mm×5 mm, and one of the surfaces of 2 mm×2 mm is trimmed into a cone shape (for example, a pyramid shape), followed by freezing with liquid nitrogen. A cross section of the frozen sample is taken with a cryostat ultramicrotome, and an electron microscope image of the obtained cross section is obtained at a magnification of 3000 times using a scanning electron microscope. The shortest interparticle distance can be obtained by measuring distances between all particles whose entire edges are included in the image and another nearest neighbor particle and calculating an average value thereof. The basic metal oxide can be identified in the image of the scanning electron microscope by, for example, mapping metal elements of the basic metal oxide by performing elemental analysis using an elemental analyzer for an electron microscope. In the molded body, the presence of the basic metal oxide at the shortest interparticle distance within the range described above accelerates the hydrolysis of the composition, and further improves the thickness reduction rate of the molded body. Further, by adding a basic metal oxide having a high degradation acceleration effect in combination, the amount of the cyclic ester to be added, which plasticizes the base material to accelerate degradation, can be reduced, resulting in an improvement in strength of the base material.

A preferable content of the basic metal oxide is preferably 0.5 parts by mass or greater, more preferably 5 parts by mass or greater, and particularly preferably 10 parts by mass or greater, and is preferably 30 parts by mass or less, more preferably 25 parts by mass or less, and particularly preferably 20 parts by mass or less, when the total of the glycolic acid polymer, the cyclic ester, the basic metal oxide, and the carboxylic anhydride is 100 parts by mass. By setting the content in this range, the thickness reduction rate of the molded body can be increased. In addition, in the molding processing, the decrease in molecular weight can be reduced, and a molded body having a preferable molecular weight is easily obtained.

A preferable average particle diameter of the basic metal oxide is preferably 5.0 μm or less, more preferably 2.0 μm or less, and particularly preferably 1.5 μm or less. By setting the particle diameter in this range, the dispersibility in the molded body becomes favorable, and a preferable shortest interparticle distance is easily obtained. The particle diameter of the basic metal oxide in the present specification refers to the particle diameter in the molded body. As a method for measuring the particle diameter, for example, elemental analysis is performed by an elemental analyzer for a scanning electron microscope, and an image can be obtained by mapping the metal elements of the basic metal oxide, and the particle diameter can be obtained by subjecting the image to image analysis processing. In the case of a shape such as an elliptical shape that can show a plurality of sizes of diameters, the maximum length of a straight line is defined as the particle diameter. The average particle diameter in the present specification refers to a value calculated as a median diameter. The method of image analysis processing after mapping is not particularly limited, and commercially available image analysis software may be used. For example, a method of converting an image obtained by mapping the metal elements of the basic metal oxide obtained using an elemental analyzer for a scanning electron microscope into a monochrome image using commercially available image analysis software, adjusting the contrast of the monochrome image so as to be at tone levels closest to those of the original image through calibration, and then measuring the particle diameter from the binarized image, and the like can be indicated.

The basic metal oxide contained in the composition can be identified from the peak pattern of the basic metal oxide using, for example, XRD measurement. If necessary, a plurality of analysis methods such as elemental analysis by an elemental analyzer for an electron microscope and FT-IR may be combined.

### (Carboxylic Anhydride)

Examples of the carboxylic anhydride contained in the composition according to the present embodiment include hexanoic anhydride, octanoic anhydride, decanoic anhydride, lauric anhydride, mystyric anhydride, palmitic anhydride, stearic anhydride, benzoic anhydride, succinic anhydride, maleic anhydride, phthalic anhydride, trimellitic anhydride, tetrahydrophthalic anhydride, butanetetracarboxylic dianhydride, 3,3′,4,4′-benzophenonetracarboxylic dianhydride, diphenylsulfone tetracarboxylic dianhydride, biphenyltetracarboxylic dianhydride, ethyleneglycol bisanhydrotrimellitate, and glycerin bisanhydrotrimellitate monoacetate, and benzene-1,2,4,5-tetracarboxylic anhydride (pyromellitic anhydride) and 3,3′,4,4′-benzophenonetetracarboxylic dianhydride are particularly preferable. One type of carboxylic anhydrides may be used alone, or two or more types thereof may be used in combination.

The structure of the carboxylic anhydride contained in the composition can be identified by, for example, performing GCMS analysis and comparing the analysis results with known compounds as standard materials. In addition, the structure of the carboxylic anhydride can be identified by using other analysis methods such as spectra obtained by NMR measurement in combination as necessary.

A content of the carboxylic anhydride in the composition is preferably 0.5 parts by mass or greater, and more preferably 1 part by mass or greater, when the total of the glycolic acid polymer, the cyclic ester, the basic metal oxide, and the carboxylic anhydride is 100 parts by mass. The content is preferably 10 parts by mass or less, and more preferably 8 parts by mass or less. When the content of the carboxylic anhydride is within the range described above, the carboxylic anhydride is less likely to bleed out from the composition, and thus the thermal stability of the composition is maintained while accelerating the degradation rate of the composition, and molding processing can be facilitated. In an aspect of an embodiment of the present invention, the content of the carboxylic anhydride in the composition is preferably 0.5 mass % or greater, and more preferably 1 mass % or greater, relative to 100 mass % of the composition. Also, the content is preferably 10 mass % or less, and more preferably 8 mass % or less.

The content of the carboxylic anhydride in the composition can be calculated from the ratio of the materials to be charged. Alternatively, for example, it can also be measured by GCMS analysis. An example of gas chromatography (GC) measurement is indicated below.

### Method for Preparing Sample:

To about 100 mg of a composition, p-chlorobenzophenone-containing dehydrated DMSO (0.4 mg/2 ml) is added and heated and dissolved at 160° C. for about 10 minutes. After the solution is cooled to room temperature, the solution is filtered. Gas chromatography (GC) measurement is performed for the obtained filtrate.

### Measurement Conditions:

Instrument: GC-2010, available from the Shimadzu Corporation
Column: RESTEK Rxi-5 ms
Column temperature: Retention at 180° C. for 4 minutes, then temperature increase to 210° C. at 10° C./min, then temperature increase to 330° C. at 40° C./min, and then retention at 330° C. for 3 minutes
Injection temperature: 250° C.

### Weight Average Molecular Weight of Composition

A weight average molecular weight (Mw) of the composition which is a material forming the molded body is preferably 150000 or greater, more preferably 160000 or greater, and even more preferably 170000 or greater, from the perspectives of maintaining of the strength of the molded body and extrusion molding. Furthermore, from the perspective of facilitating molding at the time of extrusion molding or injection molding, the Mw of the composition is preferably 500000 or less, more preferably 450000 or less, and even more preferably 400000 or less.

The weight average molecular weight of the composition can be measured by, for example, the method described below. About 10 mg of the composition is dissolved in 0.5 mL of DMSO by heating at 150° C., and then cooled to room temperature. The cooled solution is diluted to 10 mL with hexafluoroisopropanol (HFIP), and the weight average molecular weight of the composition is measured by using a gel permeation chromatograph (GPC) instrument. As the standard substance, polymethyl methacrylate (PMMA) is used. An example of the GPC instrument is Shodex GPC-104 (detector: RI; column: two HFIP-606M). Furthermore, as a solvent, HFIP containing 5 mM CF₃COONa may be used.

### Additional Component

Besides the glycolic acid polymer, the cyclic ester, the basic metal oxide, and the carboxylic anhydride, the composition may contain an additional component in a range not contrary to the object of the present invention.

Examples of such an additional component include various additives such as a degradation accelerator, a thermal stabilizer, a photostabilizer, an inorganic filler, a moisture-proof agent, a waterproof agent, a water-repellent agent, a lubricant, a hydrophilic agent, a water-absorbing agent, a nucleating agent, and a pore-forming agent. In addition, the composition may contain a polymerization initiator, a catalyst, or the like used in preparation of a polymer.

The composition can be prepared by mixing a glycolic acid polymer, a cyclic ester, a basic metal oxide, and a carboxylic anhydride. The cyclic ester may be added during the preparation of the glycolic acid polymer. When the glycolic acid polymer is produced by ring-opening polymerization of glycolide, the remaining glycolide may be used as a cyclic ester. That is, a glycolic acid polymer composition containing glycolide and a glycolic acid polymer and obtained by preparing a glycolic acid polymer, a basic metal oxide, a carboxylic anhydride, and an optional cyclic ester may be mixed to prepare the composition.

The molded body according to the present embodiment is a polyglycolic acid molded body including the composition. The thickness or diameter of the molded body is greater than 5 mm.

When the molded body according to an aspect of the present invention is held in water at 49° C., the thickness reduction rate of the molded body after a thickness reduction of 5 mm from its initial thickness (the thickness of the molded body before being held in water) is preferably 0.080 mm/hour or greater, more preferably 0.088 mm/hour or greater, and even more preferably 0.10 mm/hour or greater. Hereinafter, the “molded body after a thickness reduction of 5 mm or greater from its initial thickness when held in water at 49° C.” may be referred to as a “molded body in the late stage of degradation”.

When the thickness reduction rate of the molded body after a thickness reduction of 5 mm or greater from its initial thickness when held in water at 49° C. is 0.080 mm/hour or greater, the molded body according to an aspect of the present invention has a tensile strength at 49° C. of preferably 52 MPa or greater, more preferably of 55 MPa or greater, and even more preferably of 57 MPa or greater. The value of the tensile strength in the present specification is a value measured in accordance with ISO 527-1. Specifically, a test piece (No. 5 test piece) having a shape defined in ISO 527-1 is subjected to a tensile test at a speed of 20 mm/min at 49° C. (49° C.±1° C. in temperature), the maximum point stress exhibited until the test piece is broken is calculated, and the tensile strength of the test piece can be determined from an average value of five calculations.

As described above, the molded body according to the present embodiment contains a cyclic ester, a basic metal oxide, and a carboxylic anhydride. The cyclic ester plays a role in increasing the amount of water absorption of the glycolic acid polymer and accelerating the degradation of the molded body. The basic metal oxide and carboxylic anhydride have an action of accelerating degradation of the molded body by improving the hydrolysis rate of the glycolic acid polymer. The carboxylic anhydride has an action of stabilizing the molding processability. Specifically, the carboxylic anhydride has an action of suppressing a decrease in molecular weight of the glycolic acid polymer caused by heat during the molding processing and the basic metal oxide. In the molded body containing the cyclic ester, the basic metal oxide, and the carboxylic anhydride, the amount of water absorption and hydrolysis rate of the glycolic acid polymer are improved, and the degradation of the molded body is synergistically accelerated. As shown in Examples, the molded body according to the present embodiment has a high thickness reduction rate due to the synergistic effect of the cyclic ester, the basic metal oxide, and the carboxylic anhydride, as compared with a molded body lacking any of the cyclic ester, the basic metal oxide, and the carboxylic anhydride.

In the present specification, the thickness reduction rate means a rate at which the thickness of a non-brittle portion of the molded body decreases. The “embrittlement” means that the molded body becomes brittle due to the decrease in molecular weight of the glycolic acid polymer caused by the hydrolysis of the glycolic acid polymer. The portion of the molded body that becomes brittle is referred to as a brittle layer. The embrittlement progresses from the surface toward the center of the molded body, and the thickness of the non-brittle portion decreases from the surface side. Thus, the embrittlement progression rate indicates a positive correlation with the thickness reduction rate. Thus, in the present specification, the embrittlement progression rate of the molded body is defined as the thickness reduction rate.

The thickness reduction rate can be measured, for example, by the following method: a required number of cubic test pieces each having a side of 40 mm are prepared from the molded body. Then, the test pieces are each placed in a 1 L autoclave at a temperature of 49° C., and an immersion test is performed by filling the autoclave with water (deionized water). The test piece is retrieved after immersion at predetermined time intervals. After the test piece is left to stand overnight in a dry room (dew point: −65° C., temperature: 23° C.) and dried, the thickness of a core part (hard portion) of the test piece is measured. A reduced thickness is calculated from a difference between the thickness of the core part and the thickness of the test piece before immersion (initial thickness, specifically 40 mm). The change of the reduced thickness of the test piece over time is determined based on the measured value of the reduced thickness of the test piece measured for different immersion time periods. Here, a period in which the thickness reduction from the initial thickness is up to 5 mm is defined as an early stage of degradation, and a period in which the thickness reduction from the initial thickness is 5 mm or greater is defined as a late stage of degradation. The thickness reduction rate of the test piece having a thickness of 40 mm is calculated from the change of the reduced thickness of the test piece over time within the range of the early stage of degradation or the late stage of degradation (unit: mm/h). Examples of the method for identifying the core part include a method in which the brittle layer on the surface of the test piece is shaved off with a utility knife or the like, and the surface of each face after shaving off is regarded as the core part surface to identify the core part. Alternatively, since the color of the brittle layer changes due to a decrease in molecular weight caused by hydrolysis of the glycolic acid polymer, a method of cutting the molded body in a state of including the brittle layer to expose a cross section and identifying a portion having a color different from that of the surface layer as the core part is exemplified. The method for measuring the thickness may be any method as long as the thickness can be measured, and examples thereof include a method using a caliper or a microscope.

### Method of Producing a Molded Body

The molded body according to the present embodiment can be produced by molding the composition. The molding method is not limited. Examples of the method include injection molding, melt extrusion molding, solidification- and extrusion-molding, compression molding (press molding), and centrifugal molding.

An example of production of the molded body by solidification- and extrusion-molding will be described. Pellets made of the composition are supplied to an extruder with a cylinder set at not lower than the melting point of the composition and 255° C. or lower (typically, from 200 to 255° C.), and melt-kneaded. Then, the melt-kneaded product is extruded through an extrusion die at the tip of the extruder into the flow path of a forming die, and cooled and solidified to a temperature that is not higher than the crystallization temperature of the composition in the flow path of the forming die, and the solidified product is extruded from the tip of the forming die to the outside at a speed of 5 to 50 mm/10 minutes. The extrudate is pressurized and pulled while applying a back pressure of 1500 to 8500 kg in the forming die direction to produce a molded body which is the solidification- and extrusion-molded body. The molded body may be annealed by a heat treatment at a temperature of 150 to 230° C. for 3 to 24 hours.

An example of production of the molded body by injection molding will be described. Pellets made of the composition are supplied to an injection molding machine equipped with a mold for injection molding. The temperature of the cylinder is set to not lower than the melting point of the composition and 255° C. or lower (typically, from 200 to 255° C.), and the mold temperature is set to 0° C. or higher and not higher than the melting point of the composition (typically, from 0 to 190° C.). Then, the pellets are injection-molded at an injection pressure of 1 to 104 MPa (preferably 10 to 104 MPa) to produce a molded body which is an injection-molded body. This molded body may be annealed at a temperature that is not lower than the crystallization temperature of the composition and not higher than the melting point (typically, from 70 to 220° C.) for 1 minute to 10 hours.

The upper limit of the thickness or diameter of the molded body is not particularly limited and is preferably 500 mm or less, and more preferably 400 mm or less.

### Downhole Tool Member

A downhole tool member according to an aspect of the present invention is a member used for subterranean excavation to recover hydrocarbon resources such as petroleum and gas from underground, and includes the molded body. The molded body may be used as is as a downhole tool member, or may be subjected to a known machine processing (secondary processing) to produce a downhole tool member. Examples of the machine processing include cutting.

The shape and size of the downhole tool member according to an aspect of the present invention are not particularly limited, and for example, the thickness or diameter is from 5 to 500 mm, preferably from 20 to 300 mm, and more preferably from 30 to 200 mm. The shape of the downhole tool member may be various shapes such as a round bar shape, a plate shape, a hollow product such as a pipe, and an irregularly shaped product. A round bar, a hollow shape, or a plate shape is preferable, as it is easy to perform extrusion molding and a subsequent densification treatment and is often suitable for an extrusion-molded body that is a material for machining. In order to form a downhole tool member for petroleum excavation, particularly to form a blocking plug mandrel, a round bar shape is more preferable.

### Downhole Tool

A downhole tool according to an aspect of the present invention includes a downhole tool member. In the present specification, a device or a component thereof that is used for various well treatment such as well drilling, well closure, and fracturing and that is placed in the well is referred to as a downhole tool. The shape of the downhole tool is not particularly limited and, for example, can be a known shape. Examples of the downhole tool include a flack plug, a bridge plug, a cement retainer, a perforation gun, a ball sealer, a blocking plug, and a packer.

### SUMMARY

A molded body according to Aspect 1 of the present invention is a molded body including a glycolic acid polymer, a cyclic ester, a basic metal oxide and a carboxylic anhydride, in which a content of the cyclic ester is 21 parts by mass or less when a total mass of the glycolic acid polymer, the cyclic ester, the basic metal oxide, and the carboxylic anhydride is 100 parts by mass, the shortest interparticle distance of the basic metal oxide is 9.1 μm or less, and the molded body has a thickness or a diameter greater than 5 mm.

A molded body according to Aspect 2 of the present invention is the molded body in Aspect 1, in which, when held in water at 49° C., the molded body may have a thickness reduction rate of 0.080 mm/hour or greater after a thickness reduction of 5 mm or greater from its initial thickness may be.

A molded body according to Aspect 3 of the present invention is the molded body in Aspect 2, in which the molded body may have a tensile strength at 49° C. of 52 MPa or greater.

A molded body according to Aspect 4 of the present invention is a molded body including a glycolic acid polymer, a cyclic ester, a basic metal oxide and a carboxylic anhydride, in which, when held in water at 49° C., the molded body has a thickness reduction rate of 0.080 mm/h or greater after a thickness reduction of 5 mm or greater from its initial thickness.

A molded body according to Aspect 5 of the present invention is the molded body in any one of Aspects 1 to 4, in which the cyclic ester may be glycolide or ε-caprolactone.

A molded body according to Aspect 6 of the present invention is the molded body in any one of Aspects 1 to 5, in which the basic metal oxide may be magnesium oxide or zinc oxide.

A molded body according to Aspect 7 of the present invention is the molded body in any one of Aspects 1 to 6, in which the carboxylic anhydride may be a benzene-1,2,4,5-tetracarboxylic anhydride or a 3,3′,4,4′-benzophenonetetracarboxylic dianhydride.

A molded body according to Aspect 8 of the present invention is the molded body in any one of Aspects 1 to 7, in which the glycolic acid polymer may be a copolymer including a linear polymer chain A, the linear polymer chain A containing a repeating unit derived from glycolic acid and being chemically bonded to a polymer chain B that is different from the polymer chain A, and the polymer chain B may be derived from a polymer compound having a glass transition temperature lower than 45° C.

A molded body according to Aspect 9 of the present invention is the molded body in Aspect 8, in which the glycolic acid polymer may be a block copolymer of the polymer chain A and the polymer chain B.

A molded body according to Aspect 10 of the present invention is the molded body in any one of Aspects 1 to 9, in which the glycolic acid polymer may be a homopolymer of glycolic acid.

A molded body according to Aspect 11 of the present invention is the molded body in any one of Aspects 1 to 10, in which a weight average molecular weight of a material forming the molded body may be 150000 or greater and 500000 or less.

A downhole tool member according to Aspect 12 of the present invention includes the molded body described in any one of the first to eleventh embodiments.

A downhole tool according to Aspect 13 of the present invention includes the downhole tool member described in the twelfth embodiment.

Another aspect of the molded body according to Aspect 1 of the present invention described above is a molded body including a composition containing a glycolic acid polymer, a cyclic ester, a basic metal oxide, and a carboxylic anhydride, in which a content of the cyclic ester in the composition is 21 mass % or less, the shortest interparticle distance of the basic metal oxide is 9.1 μm or less, and the molded body has a thickness or a diameter greater than 5 mm.

Embodiments of the present invention will be further described in detail using the examples below. The present invention is not limited to the examples below, and it goes without saying that various aspects with regard to the details thereof are possible. Furthermore, the present invention is not limited to the above-described embodiments, and various modifications can be made within the scope indicated in the claims, and embodiments obtained by appropriately combining technical means disclosed in different embodiments are also included in the technical scope of the present invention. In addition, the contents of all the documents referred to herein are incorporated herein by reference in their entirety.

### EXAMPLES

Hereinafter, a glycolic acid polymer composition obtained by polymerization is referred to as a “polymer composition”. In addition, a composition containing a glycolic acid polymer (or a polymer composition), a cyclic ester, a basic metal oxide, and a carboxylic anhydride is referred to as a “molding composition”.

In the following Examples, the symbol “%” represents mass % unless otherwise noted.

### Measurement of SP Values of Glycolic Acid Polymer and Cyclic Ester

The measurement of the SP values was performed in accordance with “SP value: Foundation/Application and Calculation Method” (published by Johokiko Co., Ltd. (2005) pp. 66-67) by Hideki Yamamoto. More specifically, the SP value δ ((cal/cm³)^{1/2}) of a target compound (the glycolic acid polymer or the cyclic ester) was calculated according to the following equation (1).

$$δ = {( \sum Ecoh / \sum V )}^{1 / 2} \qquad ( 1 )$$

In Equation (1), ΣEcoh represents the sum total of Ecoh (cohesive energy density of a structural unit of a target compound (cal/cm³)), and ΣV represents V (molar volume of a structural unit of a target compound (cm³)).

The measurement results of the SP values, the difference between the SP value of the cyclic ester and the SP value of the glycolic acid polymer, and the glass transition temperature of the mixture are shown in Table 1. Note that the SP value of the glycolic acid polymer is 26.8. In addition, when two cyclic esters are contained in the mixture, the difference between the SP value of the cyclic ester and the SP value of the glycolic acid polymer is the one having a larger absolute value, of the value of the difference between the SP value of one cyclic ester and the SP value of the glycolic acid polymer and the value of the difference between the SP value of the other cyclic ester and the SP value of the glycolic acid polymer.

TABLE 1

| | | | | | | Difference | Glass |
|---|---|---|---|---|---|---|---|
| | | | | | SP value | in SP value | transition |
| | | | | | of cyclic | between | temperature |
| | Cyclic ester 1 | | Cyclic ester 2 | | ester | cyclic ester | Tg of mixture |
| Polymer | Name | wt. % | Name | wt. % | (J/cm³)^{1/2} | and PGA | (° C.) |
| PGA | — | — | — | — | — | — | 45 |
| PGA | Glycolide | 7.5 | — | — | 26.8 | 0 | 38 |
| PGA | Lactide | 9.3 | — | — | 23.1 | −3.7 | 37 |
| PGA | γ-Valerolactone | 6.5 | — | — | 21.6 | −5.2 | 29 |
| PGA | δ-Valerolactone | 6.5 | — | — | 21 | −5.8 | 31 |
| PGA | ε-Caprolactone | 7.3 | — | — | 21 | −5.8 | 31 |
| PGA | Diglycolic | 7.5 | — | — | 27.9 | 1.1 | 32 |
| | anhydride | | | | | | |
| PGA | Glutaric | 7.4 | — | — | 25.9 | −0.9 | 35 |
| | anhydride | | | | | | |
| PGA | Glycolide | 8 | Lactide | 9.3 | 23.1 | −3.7 | 25 |
| PGA | Glycolide | 8 | γ-Valerolactone | 6.5 | 21.6 | −5.2 | 17 |
| PGA | Glycolide | 8 | δ-Valerolactone | 6.5 | 21 | −5.8 | 19 |
| PGA | Glycolide | 8 | Diglycolic | 7.5 | 27.9 | 1.1 | 20 |
| | | | anhydride | | | | |
| PGA | Glycolide | 8 | Glutaric | 7.4 | 25.9 | −0.9 | 23 |
| | | | anhydride | | | | |

### Evaluation of Molding Composition and Molded Body

The following evaluations were performed for the molding compositions and the molded bodies obtained in Examples and Comparative Examples.

### Measurement of Weight Average Molecular Weight of Molded Body

Approximately 10 mg of a sample was heated and dissolved in 0.5 ml of DMSO at 150° C. and then cooled to room temperature. The cooled solution was diluted to 10 mL with hexafluoroisopropanol (HFIP), and the weight average molecular weight of the composition was measured by using a GPC instrument. As the standard substance, polymethyl methacrylate (PMMA) was used. The measurement conditions are indicated below.
Instrument: Shodex GPC-104 (detector: RI; columns: two HFIP-606M)
Solvent: 5 mM CF₃COONa in HFIP

### Measurement of Glycolide Content in Molded Body

In approximately 100 mg of a sample, p-chlorobenzophenone-containing DMSO (0.4 mg/2 ml) was added and heated and dissolved at 150° C. for approximately 10 minutes. After the solution was cooled to room temperature, the solution was filtered. Gas chromatography (GC) measurement was performed for the obtained filtrate. The measurement conditions are indicated below.
Instrument: GC-2010, available from the Shimadzu Corporation Column: RESTEK Rxi-5 ms
Column temperature: Retention at 150° C. for 5 minutes, (then temperature increase at 20° C./min), and then retention at 270° C. for 3 minutes Injection temperature: 180° C.

### Measurement of Thickness Reduction Rate of Molded Body

For the molded body, the required number of cubic test pieces each having a side of 40 mm were prepared. Then, the test piece was placed in a 1 L autoclave at a temperature of 49° C. An immersion test was then performed by filling the autoclave with water (deionized water). The test piece was retrieved after immersion at predetermined time intervals, and the cross-sectional surface was cut and exposed. After the test piece was left to stand overnight in a dry room and dried, the thickness of the core part (hard portion) of the test piece was measured. The reduced thickness was measured from the difference between the thickness of the core part and the thickness of the test piece before immersion (initial thickness, specifically 40 mm). The change of the reduced thickness of the test piece over time was determined based on the measured value of the reduced thickness of the test piece measured for different immersion time periods. Here, a period in which the thickness reduction from the initial thickness is up to 5 mm is defined as an early stage of degradation, and a period in which the thickness reduction from the initial thickness is 5 mm or greater is defined as a late stage of degradation. The thickness reduction rate of the test piece having a thickness of 40 mm was calculated from the change of the reduced thickness of the test piece over time within the range of the early stage of degradation or the late stage of degradation (unit: mm/h).

### Measurement of Tensile Strength of Molded Body

A molded body having a thickness of 5 mm or greater can be said to have practically sufficient tensile strength when the tensile strength measured by using a predetermined test piece is 52 MPa or greater. The tensile strength of the test piece can be measured according to ISO 527-1. A test piece (No. 5 test piece) having a shape defined in ISO 527-1 was subjected to a tensile test at a speed of 20 mm/min at 49° C. (49° C.±1° C. in temperature), and the maximum point stress exhibited until the test piece was broken was calculated and defined as the tensile strength of the test piece (an average value of five pieces (n=5), unit: MPa).

### Calculation of the Shortest Interparticle Distance of Basic Metal Oxide in Molded Body

The molded body was cut into a size of 2 mm×2 mm×5 mm with a razor, and one side was trimmed into a pyramid shape, followed by freezing with liquid nitrogen. The frozen sample was cross-sectioned with a cryoultramicrotome (knife temperature: 100° C., sample temperature: 120° C., chamber temperature: 120° C.). Thereafter, the sample was metallized, and then observed with a field emission scanning electron microscope “SU8220” available from Hitachi High-Technologies Corporation and subjected to elemental analyses with an elemental analyzer for an electron microscope “QUANTAX Flat QUAD” available from Bruker Corporation at a magnification of 3000 times. The elemental mapping images of the metal oxides obtained by the elemental analysis were binarized using image analysis software “MIPAR” available from LightStone Corporation, and the metal oxide particles were extracted as white images. Further, the distance from the center of gravity of an extracted metal oxide particle to the center of gravity of another extracted particle nearest the center of gravity was calculated as the shortest interparticle distance. The shortest interparticle distance was calculated for all the extracted particles as described above, and an average value thereof was calculated.

Comparison based on presence or absence of compositions of glycolic acid polymer, cyclic ester, basic metal oxide, and carboxylic anhydride

### Example 1

Glycolide (GL) as a cyclic ester, magnesium oxide (MgO) as a basic metal oxide, benzene-1,2,4,5-tetracarboxylic anhydride (PMDA) as a carboxylic anhydride, and a mixture of distearyl acid phosphate and monostearyl acid phosphate (“ADEKA STAB AX-71” available from ADEKA CORPORATION) as a thermal stabilizer were blended in polyglycolic acid (PGA, available from Kureha Corporation), and a molding composition was obtained. The contents of the cyclic ester, the basic metal oxide, and the carboxylic anhydride contained in the molding composition, and the shortest interparticle distance of the basic metal oxide are shown in Table 2. The parts by mass in each of Examples and Comparative Examples are parts by mass when the total of the polyglycolic acid (or polyglycolic acid-polyethylene glycol polymer), the cyclic ester, the basic metal oxide, and the carboxylic anhydride (or N,N-diisopropylcarbodiimide) is 100 parts by mass.

The molding composition was supplied to a feed unit of a twin-screw extrusion kneader (“2D25S”, available from Toyo Seiki Seisaku-sho, Ltd.) with a screw temperature set at from 190 to 240° C., melt-kneaded, and extrusion-molded, and thus pellets of the molding composition were obtained. Then, the pellets of the molding composition were supplied to a feed unit of an injection molding machine (“EC-100N”, available from Toshiba Machine Co., Ltd.) with a cylinder temperature set at 190 to 240° C. and injection-molded, and thus a molded body was obtained. The mold temperature in the injection molding was set to be within a range from 80 to 100° C.

### Examples 2 to 11

A molding composition and a molded body were obtained through the same procedure as in Example 1, except that the amounts of the cyclic ester, the basic metal oxide, and the carboxylic anhydride were changed. The contents of the cyclic ester, the basic metal oxide, and the carboxylic anhydride in Examples 2 to 11, and the shortest interparticle distance of the basic metal oxide are shown in Table 2.

### Example 12

A molding composition and a molded body were obtained through the same procedure as in Example 1, except that 7 parts by mass of 3,3′,4,4′-benzophenonetetracarboxylic dianhydride (BTDA) was blended as a carboxylic anhydride, and that the amounts of the cyclic ester and the basic metal oxide were changed. The contents of the cyclic ester, the basic metal oxide, and the carboxylic anhydride in Example 12, and the shortest interparticle distance of the basic metal oxide are shown in Table 2.

### Example 13

A molding composition and a molded body were obtained through the same procedure as in Example 1, except that 7.3 parts by mass of E-caprolactone (E-CL) was blended as a cyclic ester, and that the amounts of the basic metal oxide and the carboxylic anhydride were changed. The contents of the cyclic ester, the basic metal oxide, and the carboxylic anhydride in Example 13, and the shortest interparticle distance of the basic metal oxide are shown in Table 2.

### Example 14

A molding composition and a molded body were obtained through the same procedure as in Example 1, except that 14 parts by mass of zinc oxide (ZnO) was blended as a basic metal oxide, and that the amounts of the cyclic ester and the carboxylic anhydride were changed. The contents of the cyclic ester, the basic metal oxide, and the carboxylic anhydride in Example 14, and the shortest interparticle distance of the basic metal oxide are shown in Table 2.

### Comparative Example 1

A molding composition and a molded body were obtained through the same procedure as in Example 1, except that none of the cyclic ester, the basic metal oxide, and the carboxylic anhydride was blended.

### Comparative Examples 2 and 3

A molding composition and a molded body were obtained through the same procedure as in Example 1, except that neither the cyclic ester nor the basic metal oxide was blended, and that the amount of the carboxylic anhydride was changed. The contents of the carboxylic anhydride in Comparative Examples 2 and 3 are shown in Table 3.

### Comparative Examples 4 and 5

A molding composition and a molded body were obtained through the same procedure as in Example 1, except that neither the basic metal oxide nor the carboxylic anhydride was blended, and that the amount of the cyclic ester was changed. The contents of the cyclic ester in Comparative Examples 4 and 5 are shown in Table 3.

### Comparative Examples 6 to 8

In a polymerization vessel, relative to 100 parts by mass of glycolide, 0.03 parts by mass of tin dichloride as a catalyst, 1 part by mass of pentaerythritol tetrakis[3-(3,5-di-tert-butyl-4-hydroxyphenyl)propionate] as a thermal stabilizer, 2 parts by mass of polyethylene glycol (PEG, Mw 7500) as a polymerization initiator were charged. The charged contents were held under heated condition at 140° C. for 6 hours, and a polyglycolic acid-polyethylene glycol polymer (PGA-PEG) was obtained. The polyglycolic acid-polyethylene glycol polymer (PGA-PEG) obtained in the above step does not contain glycolide. A molding composition and a molded body were obtained through the same procedure as in Example 1, except that the basic metal oxide was not blended, that the polyglycolic acid-polyethylene glycol polymer (PGA-PEG) obtained in the above step was used instead of the polyglycolic acid, and that the amounts of the cyclic ester and the carboxylic anhydride were changed. The contents of the cyclic ester and the carboxylic anhydride in Comparative Examples 6 to 8 are shown in Table 3.

### Comparative Example 9

A molding composition was obtained through the same procedure as in Example 1, except that the carboxylic anhydride was not blended and that the amounts of the cyclic ester and the basic metal oxide were changed. The contents of the cyclic ester and the basic metal oxide in Comparative Example 9 are shown in Table 3. The molding composition could not be injection-molded due to thermal degradation.

### Comparative Example 10

A molding composition was obtained through the same procedure as in Example 1, except that 1 part by mass of N,N-diisopropylcarbodiimide (CDI) was blended instead of the carboxylic anhydride, and that the amounts of the cyclic ester and the basic metal oxide were changed. The contents of the cyclic ester and the basic metal oxide in Comparative Example 10 are shown in Table 3. The molding composition could not be injection-molded due to thermal degradation.

### Comparative Example 11

A molding composition and a molded body were obtained through the same procedure as in Example 1, except that the amounts of the cyclic ester, the basic metal oxide, and the carboxylic anhydride were changed. The contents of the cyclic ester and the basic metal oxide in Comparative Example 11 are shown in Table 3.

### Comparative Example 12

A molding composition and a molded body were obtained through the same procedure as in Example 1, except that the cyclic ester was not blended, and that the amounts of the basic metal oxide and the carboxylic anhydride were changed. The contents of the basic metal oxide and the carboxylic anhydride in Comparative Example 12 are shown in Table 3.

### Comparative Examples 13 and 14

A molding composition and a molded body were obtained through the same procedure as in Example 1, except that the basic metal oxide was not blended, and that the amount of the cyclic ester was changed. The contents of the cyclic ester in Comparative Examples 13 and 14 are shown in Table 3.

As shown in Table 2, the molded bodies formed from the molding compositions of Examples 1 to 14 had a thickness reduction rate in the late stage of degradation of 0.080 mm/h or greater and a tensile strength of 52 MPa or greater at 49° C., and showed good results in both the thickness reduction rate in the late stage of degradation and the tensile strength. On the other hand, as shown in Table 3, the molded bodies formed from the molding compositions of Comparative Examples 1 to 14, in which any of the cyclic ester, the basic metal oxide, and the carboxylic anhydride was not blended or the shortest interparticle distance of the basic metal oxide was large, had a thickness reduction rate in the late stage of degradation of less than 0.080 mm/h or a tensile strength of less than 52 MPa at 49° C.

TABLE 2

| | | | | | | | | | | Thickness | |
|---|---|---|---|---|---|---|---|---|---|---|---|
| | | | | | | | | | | reduction | |
| | | | | Basic metal oxide | | | | | | rate in late | |
| | | Cyclic | | | | Shortest | Carboxylic | | | stage of | Tensile |
| | | Ester | | | | interparticle | anhydride | | | degradation | strength |
| | | (parts | | | part | distance | (parts | | Mw | V₂(mm/h), | (MPa), |
| | Polymer | by mass) | | Type | by mass | (μm) | by mass) | | (g/mol) | 49° C. | 49° C. |
| Example 1 | PGA | GL | 16.1 | MgO | 1 | 1.39 | PMDA | 7 | 250000 | 0.10 | 63 |
| Example 2 | PGA | GL | 5.7 | MgO | 10 | 0.782 | PMDA | 7 | 170000 | 0.12 | 71 |
| Example 3 | PGA | GL | 6.9 | MgO | 12 | 0.81 | PMDA | 5 | 170000 | 0.13 | 62 |
| Example 4 | PGA | GL | 8.1 | MgO | 14 | 0.646 | PMDA | 5 | 180000 | 0.18 | 63 |
| Example 5 | PGA | GL | 7.9 | MgO | 14 | 0.77 | PMDA | 7 | 160000 | 0.17 | 55 |
| Example 6 | PGA | GL | 8 | MgO | 14 | 0.72 | PMDA | 10 | 170000 | 0.19 | 53 |
| Example 7 | PGA | GL | 5.8 | MgO | 16 | 0.775 | PMDA | 3 | 260000 | 0.15 | 66 |
| Example 8 | PGA | GL | 7.2 | MgO | 16 | 0.64 | PMDA | 5 | 180000 | 0.19 | 57 |
| Example 9 | PGA | GL | 6.7 | MgO | 16 | 0.64 | PMDA | 7 | 150000 | 0.25 | 54 |
| Example 10 | PGA | GL | 3.0 | MgO | 25 | 0.36 | PMDA | 5 | 160000 | 0.19 | 53 |
| Example 11 | PGA | GL | 20.6 | MgO | 7 | 1.05 | PMDA | 2.5 | 160000 | 0.15 | 52 |
| Example 12 | PGA | GL | 7.0 | MgO | 16 | 0.64 | BTDA | 7 | 190000 | 0.17 | 56 |
| Example 13 | PGA | ε-CL | 7.3 | MgO | 14 | 0.74 | PMDA | 5 | 160000 | 0.26 | 53 |
| Example 14 | PGA | GL | 13.0 | ZnO | 14 | 0.62 | PMDA | 7 | 200000 | 0.088 | 63 |

TABLE 3

| | | | | | | | | | | | Thickness | |
|---|---|---|---|---|---|---|---|---|---|---|---|---|
| | | | | | | | | | | | reduction | |
| | | | | Basic metal oxide | | | | | | | rate in late | |
| | | Cyclic | | | | Shortest | Carboxylic | | | | stage of | Tensile |
| | | Ester | | | | interparticle | anhydride | | CDI | | degradation | strength |
| | | (parts | | | part | distance | (parts | | (parts | Mw | V₂(mm/h), | (MPa), |
| | Polymer | by mass) | | Type | by mass | (μm) | by mass) | | by mass) | (g/mol) | 49° C. | 49° C. |
| Comparative | PGA | — | — | — | — | — | — | — | — | 220000 | 0.0080 | 110 |
| Example 1 | | | | | | | | | | | | |
| Comparative | PGA | — | — | — | — | — | PMDA | 5 | — | 220000 | 0.020 | 87 |
| Example 2 | | | | | | | | | | | | |
| Comparative | PGA | — | — | — | — | — | PMDA | 7.7 | — | 210000 | 0.030 | 83 |
| Example 3 | | | | | | | | | | | | |
| Comparative | PGA | GL | 30 | — | — | — | — | — | — | 220000 | 0.11 | 39 |
| Example 4 | | | | | | | | | | | | |
| Comparative | PGA | GL | 13.8 | — | — | — | — | — | — | 210000 | 0.053 | 83 |
| Example 5 | | | | | | | | | | | | |
| Comparative | PGA- | GL | 18.0 | — | — | — | PMDA | 4.4 | — | 160000 | 0.11 | 47 |
| Example 6 | PEG | | | | | | | | | | | |
| Comparative | PGA- | GL | 21.2 | — | — | — | PMDA | 7 | — | 160000 | 0.12 | 41 |
| Example 7 | PEG | | | | | | | | | | | |
| Comparative | PGA- | GL | 21.6 | — | — | — | — | — | — | 160000 | 0.10 | 51 |
| Example 8 | PEG | | | | | | | | | | | |
| Comparative | PGA | GL | 20 | MgO | 10 | — | — | — | — | Injection impossible due to | | |
| Example 9 | | | | | | | | | | thermal degradation | | |
| Comparative | PGA | GL | 7.0 | MgO | 16 | — | — | — | 1 | Injection impossible due to | | |
| Example 10 | | | | | | | | | | thermal degradation | | |
| Comparative | PGA | GL | 6.7 | MgO | 16 | 18.8 | PMDA | 3 | — | 170000 | 0.066 | 61 |
| Example 11 | | | | | | | | | | | | |
| Comparative | PGA | — | — | MgO | 20 | 1.22 | PMDA | 5 | — | 150000 | 0.055 | 72 |
| Example 12 | | | | | | | | | | | | |
| Comparative | PGA | GL | 12.0 | — | — | — | PMDA | 7 | — | 190000 | 0.062 | 68 |
| Example 13 | | | | | | | | | | | | |
| Comparative | PGA | GL | 18.0 | — | — | — | PMDA | 7 | — | 250000 | 0.078 | 61 |
| Example 14 | | | | | | | | | | | | |

Comparison based on interparticle distance of basic metal oxide

### Examples 15 to 18 and Comparative Example 15

In Examples 15 to 18 and Comparative Example 15, basic metal oxides having various average particle diameters were used, and the influences of only the magnitude of the shortest interparticle distance of the basic metal oxide on the degradation rate and the tensile strength were compared. Molding compositions and molded bodies were obtained through the same procedure as in Example 1. The types and contents of the cyclic ester, the basic metal oxide, and the carboxylic anhydride, and the average particle diameter and the shortest interparticle distance of the basic metal oxide are shown in Table 4.

TABLE 4

| | | | | | | | Thickness | |
|---|---|---|---|---|---|---|---|---|
| | | | | | | | reduction | |
| | | Cyclic | Basic metal oxide (MgO) | | | Carboxylic | rate in late | |
| | | Ester | | Average | Shortest | anhydride | stage of | Tensile |
| | | (GL, | | particle | interparticle | (PMDA, | degradation | strength |
| | | parts | part | diameter | distance | parts | V₂(mm/h), | (MPa), |
| | Polymer | by mass) | by mass | (μm) | (μm) | by mass) | 49° C. | 49° C. |
| Example 15 | PGA | 6 | 16 | 0.591 | 0.775 | 3 | 0.15 | 61 |
| Example 16 | PGA | 6 | 16 | 1.02 | 1.54 | 3 | 0.11 | 57 |
| Example 17 | PGA | 6 | 16 | 1.61 | 3.94 | 3 | 0.10 | 61 |
| Example 18 | PGA | 6 | 16 | 2.11 | 4.25 | 3 | 0.099 | 52 |
| Comparative | PGA | 6 | 16 | 7.69 | 18.8 | 3 | 0.066 | 62 |
| Example 15 | | | | | | | | |

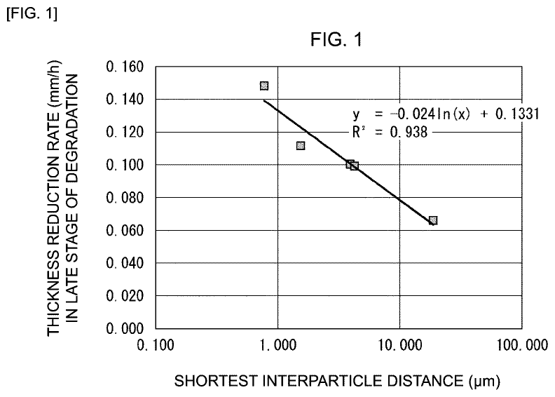

As shown in Table 4, the molded bodies formed from the molding compositions of Examples 15 to 18 showed good results in both the thickness reduction rate in the late stage of degradation and the tensile strength at 49° C. On the other hand, in Comparative Example 15 in which the shortest interparticle distance was large, the thickness reduction rate in the late stage of degradation was low. In addition, based on the results, in consideration of the correlation between the shortest interparticle distance of the basic metal oxide and the thickness reduction rate of the molded body in the late stage of degradation (FIG. 1), it was suggested that the thickness reduction rate of the molded body in the late stage of degradation was 0.080 mm/h or greater when the shortest interparticle distance of the basic metal oxide was 9.1 μm or less.

### Comparison Based on Presence or Absence of Thermal Stabilization Effect of Carboxylic Anhydride

### Examples 19 to 21 and Comparative Examples 16 to 20

In Examples 19 to 21 and Comparative Examples 16 to 20, various hydroxyl group sealing agents (CDI, silane coupling agents) were used in addition to the carboxylic anhydride, and the influences of the presence of the carboxylic anhydride and other hydroxyl group sealing agents on the thermal stability were compared. As the silane coupling agents, KBM-4803 available from Shin-Etsu Silicone Co., Ltd., KBE-9007N available from Shin-Etsu Silicone Co., Ltd., and X-12-967C available from Shin-Etsu Silicone Co., Ltd. were used. Molding compositions and molded bodies were obtained through the same procedure as in Example 1. The types and contents of the cyclic ester, the basic metal oxide, the carboxylic anhydride and the hydroxyl group sealing agent are shown in Table 5.

TABLE 5

| | | | Basic | | | | | | | | Mw |
|---|---|---|---|---|---|---|---|---|---|---|---|
| | | Cyclic | metal | Carboxylic | | | | | | | retention |
| | | Ester | oxide | anhydride | | | | | | | percentage |
| | | (GL, | (MgO, | (PMDA) | | Hydroxyl group sealing agent | | | | Mw | before |
| | | parts | parts | part | | | part | | | after | and after |
| | | by | by | by | Functional | | by | | | injection | injection |
| | Polymer | mass) | mass) | mass | group | Type | mass | Functional group | | (g/mol) | (%) |
| Example 19 | PGA | 8 | 16 | 7 | Acid | — | — | — | — | 220000 | 100 |
| | | | | | Anhydride | | | | | | |
| Example 20 | PGA | 8 | 16 | 3 | Acid | — | — | — | — | 210000 | 96 |
| | | | | | Anhydride | | | | | | |
| Example 21 | PGA | 8 | 16 | 0.5 | Acid | — | — | — | — | 190000 | 88 |
| | | | | | Anhydride | | | | | | |
| Comparative | PGA | 8 | 16 | — | — | CDI | 1 | Carbodiimide | — | 85000 | 39 |
| Example 16 | | | | | | | | | | | |
| Comparative | PGA | 8 | 16 | — | — | KBM- | 1 | Silane | Epoxy | 90000 | 41 |
| Example 17 | | | | | | 4803 | | | | | |
| Comparative | PGA | 8 | 16 | 0.5 | Acid | KBE- | 1 | Silane | Isocyanate | 150000 | 68 |
| Example 18 | | | | | Anhydride | 9007N | | | | | |
| Comparative | PGA | 8 | 16 | 0.5 | Acid | X-12- | 1 | Silane | Acid | 110000 | 50 |
| Example 19 | | | | | Anhydride | 967C | | | Anhydride | | |
| Comparative | PGA | 8 | 16 | — | — | — | — | — | — | 65000 | 30 |
| Example 20 | | | | | | | | | | | |

As shown in Table 5, in Examples 19 to 21, good results were shown in the retention percentage of the weight average molecular weight after injection molding as compared with that before injection molding. On the other hand, in Comparative Examples 16 to 19 in which a hydroxyl group sealing agent other than the carboxylic anhydride was blended, and Comparative Example 20 in which neither the carboxylic anhydride nor another hydroxyl group sealing agent was blended, the retention percentage of the weight average molecular weight after injection molding as compared with that before injection molding was low, and it was shown that the thermal stabilities in these Comparative Examples were low as compared with those of the compositions of Examples 19 to 21.

### INDUSTRIAL APPLICABILITY

The molded body according to an embodiment of the present invention has a high degradation rate and can be used for, for example, a downhole tool for well drilling.

1. A molded body comprising:
a glycolic acid polymer;
a cyclic ester;
a basic metal oxide;
and a carboxylic anhydride,
wherein a content of the cyclic ester is 21 parts by mass or less when a total mass of the glycolic acid polymer, the cyclic ester, the basic metal oxide, and the carboxylic anhydride is 100 parts by mass, the shortest interparticle distance of the basic metal oxide is 9.1 μm or less, and the molded body has a thickness or a diameter greater than 5 mm.

2. The molded body according to claim 1, wherein, when held in water at 49° C., the molded body has a thickness reduction rate of 0.080 mm/h or greater after a thickness reduction of 5 mm or greater from its initial thickness.

3. The molded body according to claim 2, wherein the molded body has a tensile strength at 49° C. of 52 MPa or greater.

4. A molded body comprising:
a glycolic acid polymer;
a cyclic ester;
a basic metal oxide;
and a carboxylic anhydride,
wherein, when held in water at 49° C., the molded body a thickness reduction rate of 0.080 mm/h or greater after a thickness reduction of 5 mm or greater from its initial thickness.

5. The molded body according to claim 1, wherein the cyclic ester is glycolide or e-caprolactone.

6. The molded body according to claim 1, wherein the basic metal oxide is magnesium oxide or zinc oxide.

7. The molded body according to claim 1, wherein the carboxylic anhydride is a benzene-1,2,4,5-tetracarboxylic anhydride or a 3,3′,4,4′-benzophenonetetracarboxylic dianhydride.

8. The molded body according to claim 1, wherein
the glycolic acid polymer is a copolymer including a linear polymer chain A, the linear polymer chain A containing a repeating unit derived from glycolic acid and being chemically bonded to a polymer chain B that is different from the polymer chain A, and
the polymer chain B is derived from a polymer compound having a glass transition temperature lower than 45° C.

9. The molded body according to claim 8, wherein the glycolic acid polymer is a block copolymer of the polymer chain A and the polymer chain B.

10. The molded body according to claim 1, wherein the glycolic acid polymer is a homopolymer of glycolic acid.

11. The molded body according to claim 1, wherein a weight average molecular weight of a material forming the molded body is 150000 or greater and 500000 or less.

12. A downhole tool member comprising the molded body described in claim 1.

13. A downhole tool comprising the downhole tool member described in claim 12.
